(19) United States
(12) Patent Application Publication
(10) Pub. No.: US 2006/0182557 A1
(43) Pub. Date: Aug. 17, 2006

(54) Device with at least one manipulator system for the shape-independent and/or size-independent connecting of individual components to form sections for transportation vehicles, such as aircraft

(75) Inventors: Holger Frauen, Hamburg (DE); Tomas Gnauck, Neu Wulmstorf (DE); Eike Klemkow, Schwerin (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/286,785

(22) Filed: Nov. 22, 2005

(30) Foreign Application Priority Data
Nov. 22, 2004 (DE) 10 2004 056 285.7

(51) Int. Cl. B65G 67/00

(52) U.S. Cl. 414/349

(57) ABSTRACT

A device with at least one manipulator system for the shape-independent and/or size-independent connection of individual components to form sections 1 for transportation vehicles, such as aircraft, is disclosed. According to one embodiment of the invention, at least one manipulator system is spatially positioned for the shape-independent and/or size-independent connection of sections by at least one positioning device that is mounted on a support base. Due to the arrangement of at least one manipulator system on at least one positioning device, individual components may be connected to form sections, regardless of the size and or shape of the sections, such as sections having substantially different cross-sectional dimensions and/or lengths. Connection of the individual components takes place by suitable processing devices that are arranged on the manipulator systems, in which processing devices, such as riveting tools, welding tools or other tools, may be spatially positioned as desired. The processing devices comprises, for example, processing elements 25, 26, 61 to 64, 75, 76 for connecting individual components.

### RELATED APPLICATION

This application claims the benefit of the filing date of German Patent Application No. 10 2004 056 285.7 filed Nov. 22, 2004, the disclosure of which is hereby incorporated herein by reference.

### FIELD OF THE INVENTION

The field relates to a device with at least one manipulator system for the shape-independent and/or size-independent connecting of individual components to form sections for transportation vehicles, such as aircraft.

### TECHNOLOGICAL BACKGROUND

At present, the process of connecting individual components to form sections in the construction of aircraft is still carried out manually. Connecting, for example, is carried out by riveting or welding tools that are manually positioned at the respective connection points.

There are many positioning devices known for positioning a riveting tool at a respective connection point or points, using a suitably designed guide or jig. In such devices, it is necessary for each section of different size to provide a special guide for controlling the path of a tool, such as a drilling tool, riveting tool, welding tool, bonding tool or the like. For example, if the guide is of annular shape, processing of annular seams on the outer surfaces of the sections, a specially adapted guide for sections of different diameters, lengths and/or cross-sectional geometries is required.

Consequently, known devices are not suitable for connecting sections of different dimensions for aircraft, such as sections with varying cross-sectional geometries and/or lengths.

### SUMMARY OF THE INVENTION

A device allows for automatically connecting individual components to form sections, the device being adaptable to dimensions and/or the shapes of the independent components or sections that are substantially different.

According to an embodiment, a device with at least one manipulator system for shape-independent and/or size-independent connecting of individual components to form sections for transportation vehicles, such as aircraft, wherein at least one manipulator system may be spatially positioned for the shape-independent and/or size-independent connection of at least one section by using at least one positioning device.

In that at least one manipulator system may be spatially positioned for shape-independent and/or size-independent connecting of at least one section by at least one positioning device, one advantage is that a device according to one embodiment of the invention allows for at least partly automatic forming of sections of different lengths and/or cross-sectional geometries (e.g. curvatures) for aircraft using just one universal device.

Another advantage is that a device may include one or more manipulator systems comprising one or more articulated robots, which provides a large degree of flexibility in the use of the device with respect to different sizes and geometries of the sections to be processed.

Another advantage is that an articulated robot may comprise a processing device, which allows for processing of the sections with a variety of different tools.

Another advantage is that a positioning device may comprise one or more vertical positioners that are moveable on at least one guiding element using a traversing unit, allowing for movement of the manipulator system over extended spatial regions such that processing of sections with a variety of geometric shapes and sizes may be carried out with just one universal device. Another advantage of this positioning device is that both the top and the bottom of the sections may be processed at the same time.

According to another embodiment of the invention at least one positioning device is arranged in each case so as to be substantially parallel to, and spaced apart from, a longitudinal side of the section, wherein each positioning device comprises at least two stationary vertical positioners.

This arrangement may allow for better positioning accuracy of the manipulator systems located on the vertical positioners because the vertical positioners may be arranged so as to be stationary. Moreover, this embodiment may allow for processing of the entire surface of each section.

According to a further embodiment of the invention at least one positioning device comprises at least one guiding element, wherein at least one traversing unit with at least one receptacle is arranged on the single guiding element or on the several guiding elements. One advantage is that precise processing of the sections in the lower region may be achieved.

According to another embodiment at least one processing device comprises at least one processing element for connecting the individual components, such as a riveting device, a welding device, a pressing device, a clamping device, a bonding device or the like.

According to yet another embodiment at least one processing device comprises at least one processing element for machining the individual components, in particular a drilling device and/or a milling device.

According to still another embodiment at least one processing device comprises at least one processing element for treating the surfaces of the individual components, such as a grinding device, painting device and/or a polishing device.

According to yet still another embodiment least one processing device comprises at least one processing element for applying sealing means.

According to a further embodiment, the device further comprises at least one control and regulating device.

According to yet a further embodiment, each of at least one positioning device comprises at least one vertical positioner, wherein the vertical positioner or the vertical positioners may be moved on at least one guiding element with the use of a traversing unit.

According to still a further embodiment, the guiding element or the several guiding elements are arranged in the region of a base such that they extend substantially parallel to, and are spaced apart from, at least one longitudinal side of the section.

According to yet still a further embodiment, in the region of at least one transverse side of the section at least one guiding element is arranged in the region of a base.

According to another embodiment, the vertical positioners may be moved parallel to the longitudinal sides of the section and/or parallel to at least one transverse side of the section.

According to still another embodiment in each case, at least one vertically movable longitudinal tie-bar is arranged between at least two vertical positioners.

According to yet another embodiment, the longitudinal tie-bar or the longitudinal tie-bars comprise at least one receptacle with at least one articulated robot.

According to yet still another embodiment, the receptacle or the receptacles may be moved on the longitudinal tie-bar or on the longitudinal tie-bars.

According to a further embodiment, at least one articulated robot is rotatably and/or movably accommodated in the region of the receptacle or the receptacles.

According to still a further embodiment, at least one positioning device is arranged in each case so as to be substantially parallel to, and spaced apart from, a longitudinal side of the section, wherein each positioning device comprises at least two stationary vertical positioners.

According to yet a further embodiment in each case, at least one vertically movable longitudinal tie-bar is arranged between at least two vertical positioners.

According to yet still a further embodiment, at least one receptacle is arranged on the longitudinal tie-bar or on the longitudinal tie-bars.

According to another embodiment the receptacle or the receptacles may be moved on the longitudinal tie-bar or the longitudinal tie-bars.

According to still another embodiment, at least one articulated robot is rotatably and/or movably accommodated in the region of at least one receptacle.

According to yet another embodiment, at least one positioning device comprises at least one guiding element, wherein at least one traversing unit is arranged on the one guiding element or on the several guiding elements.

According to yet still another embodiment, at least one guiding element is arranged in the region of the base such that it extends substantially parallel to, and is spaced apart from, at least one longitudinal side of the section.

According to a further embodiment, at least one receptacle is arranged on the traversing unit or the traversing units.

According to still a further embodiment, at least one articulated robot is rotatably and/or movably accommodated in the region of the receptacle or the receptacles.

Further advantages of the devices according to embodiments of the present invention will be apparent to those of ordinary skill in the art based on the disclosure, the drawings and the claims.

### BRIEF DESCRIPTION OF THE FIGURES

FIG. 1 is a perspective view of a first embodiment of the device according to one embodiment of the invention;

FIG. 2 is a perspective view of a second embodiment; and

FIG. 3 is a perspective view of a third embodiment.

### DETAILED DESCRIPTION OF PREFERRED EMBODIMENTS

Identical or similar elements in the figures are marked with identical or similar reference signs in order to make comparisons easier.

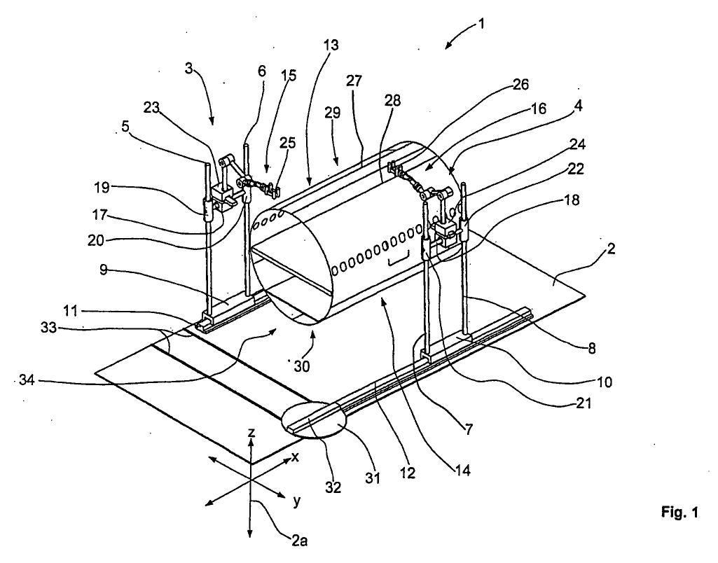

FIG. 1 shows a perspective view of a first embodiment of the device according to one embodiment of the invention. A section 1 rests on a supporting device (not shown) on a base 2. In order to illustrate the x-, y- and z-directions a coordinate system 2a is shown in the region of the base 2. It is understood that any coordinate system could be used, such as Cartesian or cylindrical coordinates systems. The supporting device, for example, comprises shoring elements (Pallungen) for supporting and holding the section 1 within the device. By a transport device (not shown), the section 1 may be moved into the device and back out of the device after its completion.

Furthermore, the device according to one embodiment of the invention comprises two positioning devices 3, 4. Each positioning device 3, 4 comprises two vertical positioners 5, 6, 7, 8. The vertical positioners 5, 6 rest on a traversing unit 9, while the vertical positioners 7, 8 are arranged on a traversing unit 10. The traversing units 9, 10, in turn, are arranged on guiding elements 11, 12 such that they may be moved in the x-direction. In this arrangement, the guiding elements 11, 12 are arranged on the base 2 such that they extend substantially parallel to, and are spaced apart from, the longitudinal sides 13, 14 of the section. The guiding elements 11, 12, for example, may be rail guides or the like, on which the traversing units 9, 10 are accommodated such that they may be moved in the x-direction. By the use of the traversing units 9, 10 in conjunction with the guide elements 11, 12, spatially extensive positioning of the positioning devices 3, 4 in the x-direction may be allowed.

Moreover, each positioning device 3, 4 may comprise a manipulator system 15, 16. In the embodiment shown in FIG. 1, the manipulator systems 15, 16 are industrial robots and/or articulated robots with at least 6 axes and several degrees of freedom. Conventional, industrial robots are well known in the art and need not be further described here.

A substantially horizontally arranged longitudinal tie-bar 17, 18 is arranged between each of a first pair of vertical positioners 5, 6 and a second pair of vertical positioners 7,8. The longitudinal tie-bars 17, 18 are accommodated on the vertical positioners 5 to 8 such that they are able to slide in the z-direction by the respective traversing units 19, 20, 21, 22. Receptacles 23, 24 are mounted on the longitudinal tie-bars 17, 18 and are arranged to support the manipulator systems 15, 16, which. The receptacles 23, 24 provide for displacement of the manipulator systems 15, 16 in both the x-direction and the y-direction. In addition, the manipulator systems 15, 16 may also be rotated by the receptacles 23, 24. The manipulator systems 15, 16 each comprise articulated arms (not designated in detail) with points of articulation that allow the positioning of the articulated arm in at least 6 axes and with several degrees of freedom, as is well known in the art.

By aid of the longitudinal tie-bars 17, 18, the manipulator systems 15, 16 may be positioned independently of the movement of the traversing unit 9, 10 and/or of the positioning of the manipulator systems 15, 16. This supplementary positioning option is used for aligning the manipulator systems 15, 16. In the end regions of the respective articulated arms, each manipulator system 15, 16 comprises a processing device, in particular processing elements 25, 26. The processing elements 25, 26, for example, may comprise drilling tools, riveting tools, welding tools, sealing tools or bonding tools in order to definitively connect the section 1, which is formed from tacked individual components, to form a finished section 1. The individual components,for example, are bottom shells, lateral shells, top shells and floor frames for forming a complete section 1. By aid of the positioning devices 3, 4, the processing elements 25, 26 may be positioned almost in any desired spatial position and/or in the x-, y- and z-directions.

As illustrated in the example of FIG. 1, the longitudinal seams 27, 28 on the top side 29 of the section 1 are produced using the manipulator systems 15, 16. The seams (not shown in detail) in the region of the bottom side 30 of the section 1 may be produced using corresponding movement of the manipulator systems 15, 16 by the use of the positioning devices 3, 4.

The device according to one embodiment of the invention allows for almost any desired spatial positioning of the processing elements 25, 26 arranged on the ends of the articulated arms of the manipulator systems 15, 16 by using the positioning devices 3, 4 to complement the movement options of the manipulator systems 15, 16 themselves. In this arrangement, from several individual components, such as bottom shells, lateral shells, top shells and floor frames, sections 1 having different diameters and/or lengths may be connected to form finished sections 1 with the use of just one universal device.

Furthermore, in one example, the device comprises a turning apparatus 31 with a guiding element 32 arranged thereon. The turning apparatus 31 itself may again be moved on guiding elements 33 along a traverse side 34 of the section. This embodiment allows for complete processing of the section 1 by using just one positioning device 3, 4. For example, if the positioning device 4 is initially situated in the region of the longitudinal side 14 of the section, the seams situated in this region may be produced between the individual components of the section 1; in other words they may be finally connected by using riveting, welding, bonding or the like. If, subsequently, the connection process is to be continued in the opposite region of the longitudinal side 13 of the section, then the entire positioning device 4 is at first moved onto the turning apparatus 31 with the guide elements 32 arranged thereon. In this arrangement the guiding element 32 is designed in such a way that it connects substantially directly and seamlessly with the guiding element 12 in the position of the turning apparatus 31 shown. Subsequently, the turning apparatus 31 together with the positioning device 4 may be turned on its vertical axis. The turning apparatus 31 with the positioning device 4 situated thereon may then be moved, on the guiding elements 33, substantially parallel to the transverse axis 34 of the section and/or in the y- direction. In this arrangement, the guiding elements 33 do not have to be designed such that they correspond to the guiding elements 11, 12 and 32.

In an alternative embodiment the guiding elements 11, 12 and 32, for example, may be implemented as an air cushion table or the like.

The option of turning the turning apparatus 31 allows for processing of the transverse side 34 of the section 1, if so required. If the positioning device 4 situated in the region of the transverse side 34 of the section is to be transferred to the longitudinal side 13 of the section, the turning apparatus 31 must initially be turned on its vertical axis until the positioning device 4 may be transferred from the guiding element 32 to the guiding element 11, i.e. the guiding elements 11 and 32 need to be in alignment. Subsequently, the section 1 may be processed using the manipulator system 16 arranged on the positioning device 4, due to the transferring of the positioning device 4 along the longitudinal side 13 of the section.

The above-described embodiment of the device according to one embodiment of the invention comprises an additional turning apparatus allows for processing of a section 1 using just a single positioning device 3, 4, which may result in significant cost savings. The turning apparatus 31 also may allow for processing of the section 1 in the region of its transverse side 34 by using one of the positioning devices 3, 4.

In order to provide the aforementioned spatial movement options of the device according to one embodiment of the invention in the x-, y- and z-directions the positioning devices 3, 4 comprise a series of actuators (not shown in detail) that are controlled by a control and regulating device (also not shown in detail). In this arrangement the control and regulating device is used to fully monitor and control the movement sequences of the positioning devices 3, 4, such as the vertical positioners 5 to 8, the traversing units 9, 10, the traversing units 19 to 22, the turning apparatus 31 and the manipulator systems 15, 16 with the processing elements 25, 26 arranged thereon. Such actuators are devices that are well known in the art, and the integration of actuators need not be shown in the drawings.

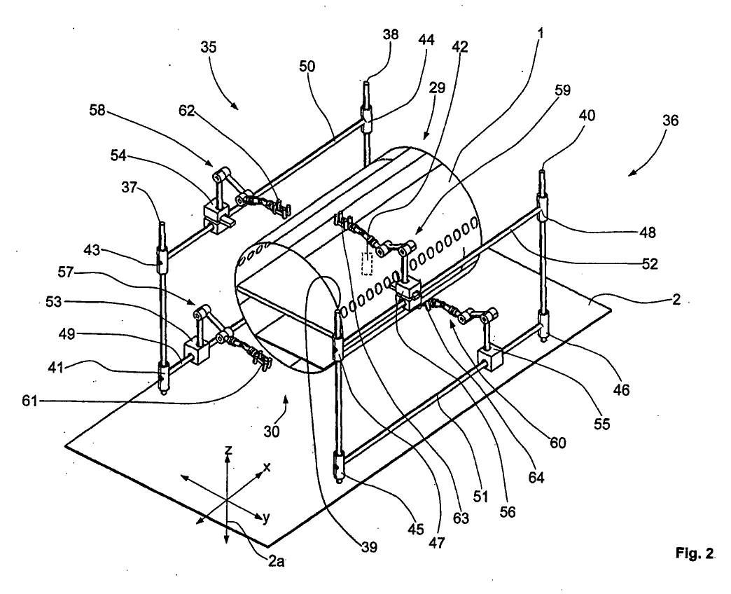

FIG. 2 shows a perspective view of a second embodiment of a device with the coordinate system 2a, to illustrate the x-, y- and z-directions. A section 1 is situated above the base 2, between two positioning devices 35, 36, and rests on the supporting device (not shown).

Each of the two positioning devices 35, 36 comprises two vertical positioners 37, 38, 39, 40. Traversing units 41, 42, 43, 44 and 45, 46, 47, 48 are slidably accommodated on the vertical positioners 37, 38 and 39, 40 such that said traversing units 41, 42, 43, 44 and 45, 46, 47, 48 may be moved in the z-direction, i.e. in vertical direction. The traversing units 41 to 48, for example, may be designed as moveable bushes or moveable carriages that may be moved on the vertical positioners 37 to 40. The traversing units 41, 42 are interconnected by a longitudinal tie-bar 49. The traversing units 43, 44 are interconnected by the longitudinal tie-bar 50. The traversing units 45, 46 are interconnected by the longitudinal tie-bar 51, while the traversing units 47, 48 are analogously interconnected by the longitudinal tie-bar 52.

The longitudinal tie-bars 49 to 52 may move independently of each other in the z-direction, i.e. in vertical direction, along the vertical positioners 37 to 40. In this arrangement the longitudinal tie-bars 49 to 52 move substantially parallel to the base 2 in order to prevent distortion.

A receptacle 53, 54, 55, 56 is mounted and arranged on each of the longitudinal tie bars 49 to 52. Two receptacles 54, 56 are shown to be displaceable in both the x-direction and the y-direction, for example. Another two receptacles 53, 55 are not shown to have mechanism for sliding in the y-direction. Any of the receptacles 53 to 56 may be selected to be displaceable, such as by sliding, in the y-direction, the x-direction and the z-direction; however, each-additional direction of displacement increases the cost of procuring and maintaining the receptacles. In one example, several receptacles are provided on a longitudinal tie-bar. Only one receptacle 53-56 is shown on each longitudinal bar 49-52 in FIG. 2 in order to make the drawing more easily understood. One advantage of having a plurality of receptacles on each longitudinal bar is that manufacturing times at each station in an assembly process is reduced.

The receptacles 53 to 56 accommodate the manipulator systems 57, 58, 59, 60 such that they are rotatable on their respective vertical axis. The manipulator systems 57 to 60, in one example, are conventional standard industrial robots or articulated robots with articulated arms (not designated in detail in FIG. 2) which may have at least six degrees of freedom. For this purpose, the articulated arms comprise several points of articulation (also not shown).

In each of the end regions of the articulated arms, processing devices, such as processing elements 61, 62, 63, 64, are arranged. The processing elements 61 to 64, for example, may be drilling tools, riveting tools, welding tools or bonding tools. By using the processing elements 61 to 64 connection of the individual components that form the section 1 may be allowed. The design according to one embodiment of the invention of the positioning devices 35, 36 allows for almost any desired spatial positioning of the processing elements 61 to 64 in the x-, y- and z-directions such that sections of different sizes, such as different diameters and/or lengths, may be processed with the above-described universal device.

Furthermore, the positioning devices 35, 36 also comprise actuators (not designated in detail) that are controlled by a control and regulating device (also not designated in detail). The control and regulating device controls and monitors such as the movement sequences of the following: the vertical positioners 37 to 40, the traversing units 41 to 48, the longitudinal tie-bars 49 to 52, the receptacles 53 to 56, the manipulator systems 57 to 60 and the processing elements 61 to 64.

Compared to the embodiment of FIG. 1, due to its stationary vertical positioners 37 to 40, the embodiment of FIG. 2 allows for improved positioning accuracy of the processing elements 61 to 64 relative to the section 1 to be achieved while at the same time providing a simpler design, which may have the advantage of costing less to procure and maintain. Moreover, the top side 29 and the bottom side 30 of the section 1 may each be processed at the same time on both sides, which has the advantage of reducing the manufacturing time.

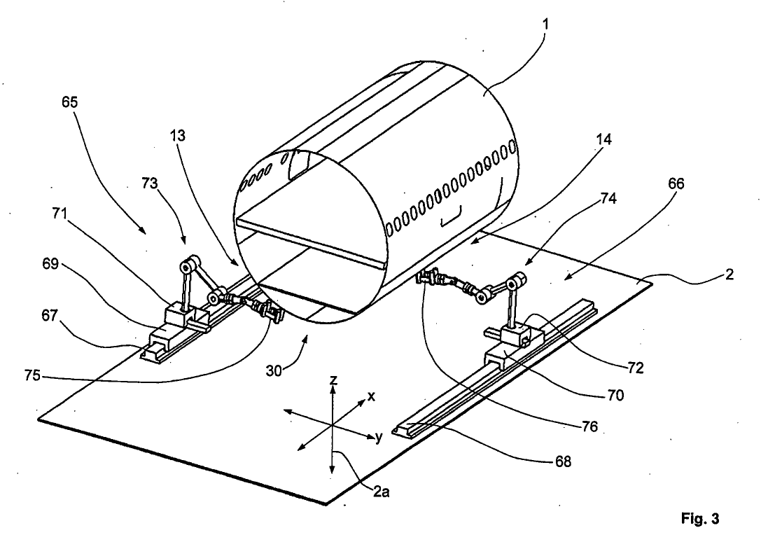

In FIG. 3, a perspective view of a third embodiment of the device, the coordinate system 2a, to illustrate the x-, y- and z-directions. Section 1 is arranged above the base 2 and rests on the supporting device (not shown).

On each longitudinal side 13, 14 of the section, a positioning device 65, 66 is arranged. However, several positioning devices 65, 66 may be provided on each longitudinal side 13, 14 of the section. Guiding elements 67 and 68 are arranged in the region of the base 2 such that they extend substantially parallel to, and are spaced apart from, the longitudinal sides 13, 14 of the section.

On each guiding element 67, 68 a traversing unit 69, 70 is arranged. The traversing units 69, 70 are designed such that they may be moved in the x-direction on the guiding elements 67, 68. The guiding elements 67, 68, for example, may be guide rails, on which the traversing units 69, 70 are accommodated so as to be movable. As an alternative, the traversing units, for example, may be formed as air cushion tables that may be freely positioned in the x- and y-directions on the base 2.

Receptacles 71, 72 are arranged on the traversing units 69, 70. The receptacles 71, 72 are arranged on the traversing units 69, 70 such that they are slidable at least in the x-direction and in the y-direction. Two manipulator systems 73, 74 are again accommodated on the receptacles 71, 72, wherein the manipulator systems 73, 74 are rotatable on their respective vertical axis. Each of the manipulator systems 73, 74 is formed as a known standard industrial robot and/or articulated robot with an articulated arm having at least 6 axes, wherein each of the manipulator systems 73, 74 having several degrees of freedom. To this purpose, the articulated arms, among other things, comprise points of articulation (not shown in detail in FIG. 3). Processing devices, such as processing elements 75, 76, are arranged in the end region of each articulated arm. The processing elements 75, 76, for example, may be drilling tools, riveting tools, welding tools or bonding tools, with the processing elements 75, 76 being used such as producing seams. Each receptacle 71, 72 may comprise several manipulator systems 73, 74.

Furthermore, the device also comprises a control and regulating device (not shown in detail) for controlling the movement sequences of the positioning devices 65, 66, such as the guiding elements 67, 68, the traversing units 69, 70, the receptacles 71, 72 and the manipulator systems 73 and 74.

Moreover, actuators and measuring systems (not shown in detail in FIG. 3) are also provided, which actuators and measuring systems are used to drive the traversing units 69, 70, the receptacles 71, 72, the manipulator systems 73, 74 and to operate the processing elements 75, 76, as well as to acquire the movement sequences and/or the exact positions in the x-, y- and z-directions, of the above-mentioned devices. All actuators are monitored by the control and regulating device.

The shown embodiment of the device also allows for desired spatial positioning of the processing elements 75, 76 in the x-, y- and z-directions. The guiding elements 67, 68, in one example, provide a broad positioning range for the manipulator systems 73, 74 in the x-direction, while the receptacles 71, 72 in conjunction with the manipulator systems 73, 74 provide alignment, with alignment as precise as allowable and at the same time extends to almost any spatial position, of the processing elements 75, 76, such as along the x-, y- and z-directions.

The device according to the third embodiment may be designed to produce longitudinal and transverse seams in the region of the bottom side 30 of the section 1 in order to connect the individual components to form a finished section 1. Furthermore, the manipulator systems 73, 74 are also guided close to the ground by the guiding elements such that short lever arms result in relatively high positioning accuracy. The device shown also allows to flexibly construct sections of different sizes, such as sections with different diameters and/or lengths, in just one versatile and universal device. In one embodiment, the system allows for rotation of the section 1, such that the device of FIG. 3 is capable of being used on all sides of the section 1. This has the advantage of allowing the manipulator systems 73, 74 to be shortened compared to manipulator systems 73, 74 that extend to the midline of the section 1, which may have the advantage of increasing displacement accuracy.

In all three of the embodiment described above, according to FIGS. 1 to 3 the device according to one embodiment of the invention also allows largely fully-automatic production of seams, such as by drilling, riveting, welding, bonding or the like, for largely shape-independent and/or size-independent connection of individual components to form sections for aircraft. By using the device according to one embodiment of the invention, sections of different cross-sectional geometric shapes and/or different lengths may be formed at least partly automatically by connecting individual components.

With the device according to one embodiment of the invention, sections for a broad range of aircraft types and/or various derivatives of an aircraft type may be constructed, at least partially automatically, from various individual components using one and the same device. Moreover, the device is also suitable for the shape-independent and/or size-independent assembly of sections made of individual components for other transport vehicles, for example, for land craft and water craft.

It should be noted that the terms “comprising” and “including” do not exclude other elements or steps and the “a” or “an” does not exclude a plurality. Also elements described in association with different embodiments may be combined. It should also be noted that reference signs in the claims shall not be construed as limiting the scope of the claims.

List of Reference Characters

1 Section
2 Base
2a Coordinate system
3 Positioning device
4 Positioning device
5 Vertical positioner
6 Vertical positioner
7 Vertical positioner
8 Vertical positioner
9 Traversing unit
10 Traversing unit
11 Guiding element
12 Guiding element
13 Longitudinal side of the section
14 Longitudinal side of the section
15 Manipulator system
16 Manipulator system
17 Longitudinal tie-bar
18 Longitudinal tie-bar
19 Traversing unit
20 Traversing unit
21 Traversing unit
22 Traversing unit
23 Receptacle
24 Receptacle
25 Processing element
26 Processing element
27 Longitudinal seam
28 Longitudinal seam
29 Top side
30 Bottom side
31 Turning apparatus
32 Guiding element
33 Guiding element
34 Transverse side of the section
35 Positioning device
36 Positioning device
37 Vertical positioner
38 Vertical positioner
39 Vertical positioner
40 Vertical positioner
41 Traversing unit
42 Traversing unit
43 Traversing unit
44 Traversing unit
45 Traversing unit
46 Traversing unit
47 Traversing unit
48 Traversing unit
49 Longitudinal tie-bar
50 Longitudinal tie-bar
51 Longitudinal tie-bar
52 Longitudinal tie-bar
53 Receptacle
54 Receptacle
55 Receptacle
56 Receptacle
57 Manipulator system
58 Manipulator system
59 Manipulator system
60 Manipulator system
61 Processing element
62 Processing element
63 Processing element
64 Processing element
65 Positioning device
66 Positioning device
67 Guiding element
68 Guiding element
69 Traversing unit
70 Traversing unit
71 Receptacle
72 Receptacle
73 Manipulator system
74 Manipulator system
75 Processing element
76 Processing element

1. A device for shape independent, size independent or both shape and size independent connecting of individual components for building sections of transport vehicles wherein the device comprises:
at least one manipulator system; and
at least one positioning device;
wherein the positioning device is adapted to spatially position the at least one manipulator system such that the manipulator system is capable of joining shape independent, size independent or both shape and size independent individual components to build sections of transport vehicles.

2. The device of claim 1, wherein the at least one manipulator system comprises at least one articulated robot.

3. The device of claim 2, wherein the at least one articulated robot comprises at least one processing device.

4. The device of claim 3, wherein the at least one processing device comprises:
at least one processing element adapted to connect the individual components.

5. The device of claim 4, wherein the at least one processing element is one of the group consisting of:
a riveting device, a welding device, a pressing device, a clamping device, and
a bonding device.

6. The device of claim 3, wherein the at least one processing device comprises:
at least one processing element adapted to machine the individual components.

7. The device of claim 6, wherein the at least one processing element is one of the group consisting of:
a drilling device, and a milling device.

8. The device of claim 3, wherein the at least one processing device comprises:
at least one processing element adapted to treat the surfaces of the individual components.

9. The device of claim 8, wherein the at least one processing element is one of the group consisting of a grinding device, a painting device, and a polishing device.

10. The device of claim 3, wherein the at least one processing device comprises:
at least one processing element adapted to apply sealing means.

11. The device of claim 1, further comprising:
at least one control unit, at least one regulating unit, or both at least one control unit and at least one regulating unit.

12. The device of claim 1, further comprising:
a traversing unit; and
at least one guiding element,
wherein the at least one positioning device comprises at least one vertical positioner, wherein the traversing unit is adapted to move the at least one vertical positioner on the at least one guiding element.

13. The device of claim 12, further comprising:
a base, wherein the at least one guiding element is arranged in a region of the base in such a way that the at least one guiding element extends substantially along the longitudinal direction and is spaced apart from at least one longitudinal side of the sections of the transport vehicle.

14. The device of claim 12, further comprising:
a base, wherein the at least one guiding element is arranged in a region of at least one transverse side of the sections of the transport vehicle.

15. The device of claim 12, wherein the at least vertical positioner is displaceable in a longitudinal direction along longitudinal sides of the sections of the transport vehicle, a transverse direction along a transverse side of the sections of the transport vehicle or both thereof.

16. The device of claim 12, further comprising:
at least two vertical positioners, and
at least one vertically moveable longitudinal tie-bar,
wherein the at least one vertically moveable longitudinal tie-bar is arranged between the at least two vertical positioners.

17. The device of claim 16, wherein in each case between two vertical positioners at least one vertically moveable longitudinal tie-bar is arranged.

18. The device of claim 16, wherein the at least one longitudinal tie-bar comprises at least one receptacle having at least one articulated robot.

19. The device of claim 18, wherein the at least one receptacle is moveable on the at least one longitudinal tie-bar.

20. The device of claim 18, further comprising:
at least one articulated robot, wherein the at least one articulated robot is rotatably and/or movably accommodated in the region of the at least one receptacle.

21. The device of claim 1, wherein the at least one positioning device comprises:
at least two stationary vertical positioners; and the at least one positioning device is arranged so as to be substantially parallel to, and spaced apart from, a longitudinal side of the section.

22. The device of claim 21, further comprising:
at least one vertically movable longitudinal tie-bar, wherein the at least one vertically movable longitudinal tie-bar is arranged between the at least two vertical positioners.

23. The device of claim 21, wherein in each case between two vertical positioners at least one vertically moveable longitudinal tie-bar is arranged.

24. The device of claim 22, further comprising:
at least one receptacle, wherein the at least one receptacle is arranged on the at least one longitudinal tie-bar.

25. The device of claims 24, wherein the at least one receptacle is moveable on the at least one longitudinal tie-bar.

26. The device of claim 24, further comprising:
at least one articulated robot, wherein the at least one articulated robot is rotatably mounted, translatably mounted or both rotatably and translatably mounted on the at least one receptacle.

27. The device of claims 1, further comprising:
at least one traversing unit, wherein the at least one positioning device comprises at least one guiding element, wherein the at least one traversing unit is arranged on the at least one guiding element.

28. The device of claim 27, further comprising:
a base, wherein the at least one guiding element is arranged in the region of the base in such a way that it extends substantially parallel to, and is spaced apart from, at least one longitudinal side of the section.

29. The device of claim 27, further comprising:
at least one receptacle, wherein the at least one receptacle is arranged on the at least one traversing unit.

30. The device of claim 29, further comprising:
at least one articulated robot, wherein the at least one articulated robot is rotatably and/or movably accommodated in the region of the at least one receptacle.
